(19) United States
(12) Patent Application Publication
(10) Pub. No.: US 2005/0199861 A1
(43) Pub. Date: Sep. 15, 2005

(54) MANUFACTURING METHOD FOR TRANSPARENT AND CONDUCTIVE COATINGS

(76) Inventors: L. W. Wu, Auburn, AL (US); Wen-Chiang Huang, Auburn, AL (US)

Correspondence Address: Wen-Chiang Huang, 2076, S. Evergreen Dr., Auburn, AL, 36830, US

(21) Appl. No.: 10/013,282

(22) Filed: Dec. 12, 2001

(51) Int. Cl. H01B 1/08

(52) U.S. Cl. 252/518.1

(57) ABSTRACT

A method for producing a transparent, electrically conductive coating onto a substrate. The method includes the steps of (a) providing an ionized arc nozzle which includes a consumable electrode, a non-consumable electrode, and a working gas flow to form an ionized arc between the two electrodes, wherein the consumable electrode provides a metal material vaporizable from the consumable electrode by the ionized arc; (b) operating the arc nozzle to heat and at least partially vaporize the metal material for providing a stream of nanometer-sized metal vapor clusters into a chamber in which the substrate is disposed; (c) introducing a stream of oxygen-containing gas into the chamber to impinge upon the stream of metal vapor clusters and exothermically react therewith to produce substantially nanometer-sized metal oxide clusters; and (d) directing the metal oxide clusters to deposit onto the substrate for forming the coating.

### FIELD OF THE INVENTION

The present invention is directed to a method for producing an optically transparent and electrically conductive coating on a substrate. The coated substrate is most suitable for use as electrodes in liquid crystal displays (LCD), electro-luminescence displays, anti-static shields, and electromagnetic wave shields, etc.

### BACKGROUND OF THE INVENTION

The following U.S. patents represent the state of the art of the manufacturing methods and apparatus for optically transparent and electrically conductive coatings or substrates:
1. P. Vilato, et al., “Product with glass substrate carrying a transparent conductive layer containing zinc and indium and process for obtaining it,” U.S. Pat. No. 5,206,089 (Apr. 27, 1993).
2. M. Sakakibara, et al., “Sputtering target and method for producing same,” U.S. Pat. No. 5,435,826 (Jul. 25, 1995).
3. M. Kawata, et al., “Electroconductive substrate and method for forming same,” U.S. Pat. No. 5,763,091 (Jun. 9, 1998).
4. K. H. Goy, et al., “Target for cathodic sputtering and method for producing the target,” U.S. Pat. No. 5,762,768 (Jun. 9, 1998).
5. M. Schlott, et al., “Process for the production of partially reduced indium oxide-tin oxide targets,” U.S. Pat. No. 5,531,948 (Jul. 2, 1996).
6. M. Orita, et al., “Electroconductive oxide electrodes and devices using the same,” U.S.

Pat. No. 5,843,341 (Dec. 1, 1998).
7. T. Hayashi, et al., “Composite conductive powder and conductive film formed from the powder,” U.S. Pat. No. 5,772,924 (Jun. 30, 1998).
8. A. Toufuku, et al., “Coating solution for forming a transparent and electrically conductive film,” U.S. Pat. No. 5,785,897 (Jul. 28, 1998).
9. Y. Watanabe, et al., “Electroconductive oxide particle and processes for its production,” U.S. Pat. No. 5,861,112 (Jan. 19, 1999).
10. A. Kaijou, et al., “Transparent electrically conductive layer, substrate, and material,” U.S.

Pat. No. 5,972,527 (Oct. 26, 1999).
11. T. Hirai, et al., “Substrate with transparent conductive coating and display device,” U.S.

Pat. No. 6,180,030 (Jan. 30, 2001).

Optically transparent and electro-conductive substrates can be obtained by two primary methods. The first method involves producing a metal oxide thin film, such as indium-tin oxide (hereinafter referred to as “ITO”) or antimony-tin oxide (“ATO”), on a transparent glass or plastic substrate by sputtering or chemical vapor deposition (CVD). The second method involves coating a transparent, electro-conductive ink on a support such as a glass substrate. The ink composition contains a powder of ultra-fine, electro-conductive particles having a particle size smaller than the smallest wavelength of visible rays. The ink is then dried on the support, which is then baked at temperatures of 400° C. or higher.

The first method requires the utilization of expensive devices and its reproducibility and yield are low. Furthermore, the procedure is tedious and time-consuming, typically involving the preparation of fine oxide particles, compaction and sintering of these fine particles to form a target, and then laser- or ion beam-sputtering of this target in a high-vacuum environment. Therefore, it was difficult to obtain transparent electro-conductive coatings that are of low prices. The electro-conductive film formed on the support by the second method tends to have some gaps remaining between the ultra-fine particles thereon so that light scatters on the film, resulting in poor optical properties. In order to fill the gaps, heretofore, a process has been proposed in which a glass-forming component is incorporated into the transparent, electro-conductive ink prior to forming the transparent, electro-conductive substrate. However, the glass-forming component is problematic in that it exists between the ultra-fine, electro-conductive particles, thereby increasing the surface resistivity of the electro-conductive film to be formed on the support. For this reason, therefore, it was difficult to satisfy both the optical characteristics and the desired surface resistivity conditions of the transparent, electro-conductive substrate by the above-mentioned second method. In addition, the transparent, electro-conductive substrate formed by the second method has exhibited poor weatherability. When the substrate is allowed to stand in air, the resistance of the film coated thereon tends to increase with time.

The present invention has been made in consideration of these problems in the related prior arts. One object of the present invention is to provide a cost-effective method for directly forming a transparent, electrically conductive coating onto a glass or plastic substrate without having to go through intermediate steps such as powder production, compaction and sintering of powder to form a target, and then the sputtering. In order to produce a uniform, thin, and optically transparent oxide coating on a glass substrate, it is essential to produce depositable oxide species that are in the vapor state prior to striking the substrate. These oxide species are preferably individual oxide molecules or nanometer-sized clusters.

In one embodiment of the present invention, a method entails producing ultra-fine vapor clusters of oxide species and directing these clusters to impinge upon a substrate, permitting these clusters to become solidified thereon to form a thin coating layer. These nano clusters are produced by operating an ionized arc nozzle in a chamber to produce metal clusters and by introducing an oxygen-containing gas into the chamber to react with the metal vapor clusters, thereby converting these metal clusters into nanometer-sized oxide clusters. The heat generated by the exothermic oxidation reaction can in turn be used to accelerate the oxidation process and, therefore, make the process self-sustaining or self-propagating. The great amount of heat released can also help to maintain the resulting oxide clusters in the vapor state. Rather than cooling and collecting these clusters to form individual powder particles, these nanometer-sized vapor clusters can be directed to form an ultra-thin, nano-grained oxide coating onto a glass or plastic substrate. Selected oxide coatings such as zinc oxide, ITO and ATO, are optically transparent and electrically conductive.

In related prior arts, ionized arc methods have been used for producing nano-scaled powder particles, but not nano-grained thin coatings. For instance, Saiki, et al. (U.S. Pat. No. 4,812,166, Mar. 14, 1989) disclosed a method that involved vaporizing a starting material by supplying this material into a plurality of direct-current (DC) plasma currents combined at a central axis of a work coil for generating high frequency induction plasma positioned under the DC plasma-generated zone. Another example of plasma arc based apparatus for powder production is disclosed by Araya, et al. (U.S. Pat. No. 4,732,369, Mar. 22, 1988 and U.S. Pat. No. 4,610,718, Sep. 9, 1986). The apparatus for producing ultra-fine particles by arc energy comprises a generating chamber for generating ultra-fine particles, an electrode positioned opposite to a base material so as to generate an electric arc, a suction opening for sucking the particles generated in the chamber, a trap for collecting the particles sucked from the suction opening, and a cooler positioned between the suction opening and the trap for cooling the sucked ultra-fine particles. Still another example of a plasma arc based process for synthesizing nano particles was disclosed by Parker, et al. (U.S. Pat. No. 5,460,701, Oct. 24, 1995; U.S. Pat. No. 5,514,349, May 7, 1996 and U.S. Pat. No. 5,874,684, Feb. 23, 1999). The system used in this process includes a chamber, a non-consumable cathode shielded against chemical reaction by a working gas, a consumable anode vaporizable by an arc formed between the cathode and the anode, and a nozzle for injecting at least one of a quench and reaction gas in the boundaries of the arc.

Glazunov, et al. (U.S. Pat. No. 3,752,610, Aug. 14, 1973) disclosed a powder-producing device that includes a rotatable, consumable electrode and a non-consumable electrode. In a method proposed by Clark (U.S. Pat. No. 3,887,667, June 3, 1975), an arc is struck between a consumable electrode and a second electrode to produce molten metal which is collected, held and homogenized in a reservoir and subsequently atomized to produce powdered metals. Akers (U.S. Pat. No. 3,975,184, Aug. 17, 1976) developed a method for powder production, which entails striking an electric arc between an electrode and the surface of a pool of molten material. The arc rotates under the influence of a magnetic field to thereby free liquid particles from the surface of the pool. The liquid particles are then quenched to become a solid powder material. Uda, et al. (e.g., U.S. Pat. No. 4,376,740, Mar. 15, 1983) taught a process for producing fine particles of a metal or alloy. The process involves contacting a molten metal or alloy with activated hydrogen gas thereby to release fine particles of the metal or alloy. The method disclosed by Ogawa, et al. (U.S. Pat. No. 4,610,857, Sep. 9, 1986) entails injecting a powder feed material into a plasma flame created in a reactive gas atmosphere. The powder injection rate is difficult to maintain and, with a high powder injection rate, a significant portion of the powder does not get vaporized by the plasma flame.

It is thus an object of the present invention to adapt improved versions of ionized or plasma arc methods for the production of nano-grained coatings.

It is another object of the present invention to provide a method for directly depositing an optically transparent and electrically conductive coating onto a solid substrate.

It is a further object of the present invention to provide a method for the mass production of transparent and conductive coatings.

### SUMMARY OF THE INVENTION

A preferred embodiment of the present invention is a method for producing an optically transparent and electrically conductive coating onto a substrate. The method includes four primary steps: (a) providing an ionized arc nozzle that includes a consumable electrode, a non-consumable electrode, and a working gas flow to form an ionized arc between the two electrodes, wherein the consumable electrode providing a metal material vaporizable from the consumable electrode by the ionized arc; (b) operating the arc nozzle to heat and at least partially vaporize the metal material for providing a stream of nanometer-sized metal vapor clusters into a chamber in which the substrate is disposed; (c) introducing a stream of oxygen-containing gas into the chamber to impinge upon the stream of metal vapor clusters and exothermically react therewith to produce substantially nanometer-sized metal oxide clusters; and (d) directing the metal oxide clusters to deposit onto the substrate for forming the coating.

In the first step, the method begins with feeding a wire or rod of either a pure metal or metal alloy onto an electrode (referred to as a consumable electrode) in the upper portion of a coating chamber. A non-consumable electrode is disposed in the vicinity of the consumable electrode. The proximal ends of the two electrodes are inclined at an angle relative to each other. The opposite ends of these two electrodes are connected to a high-current power source. In the second step, the high currents strike an ionized arc between the proximal ends of the two electrodes in the presence of a working gas. The ionized arc heats and vaporizes the wire or rod tip to form nano-sized metal vapor clusters. While the leading tip of a wire or rod is being consumed by the arc, the wire or rod is continuously or intermittently fed into an arc zone. This, along with the constant supply of a working gas, helps to maintain a relatively stable arc. In the third step, an oxygen-containing gas is introduced into the chamber to react with the metal vapor clusters to form metal oxide clusters. The oxygen-containing gas serves to provide the needed oxygen for initiating and propagating the exothermic oxidation reaction to form the oxide clusters in the liquid or, preferably, vapor state, which are then directed to deposit onto the substrate to form a thin, nano-grained coating.

The present invention provides a low-cost method that is capable of readily heating up the metal wire to a temperature as high as 6,000° C. In an ionized arc, the metal is rapidly heated to an ultra-high temperature and is vaporized essentially instantaneously. Since the wire or rod can be continuously fed into the arc-forming zone, the arc vaporization is a continuous process, which means a high coating rate.

The presently invented method is applicable to essentially all metallic materials, including pure metals and metal alloys. When high service temperatures are not required, the metal may be selected from the low melting point group consisting of antimony, bismuth, cadmium, cesium, gallium, indium, lead, lithium, rubidium, tin, and zinc. When a high service temperature is required, a metallic element may be selected from the high-melting refractory group consisting of tungsten, molybdenum, tantalum, hafnium and niobium. Other metals with intermediate melting points such as copper, zinc, aluminum, iron, nickel and cobalt may also be selected. Indium, tin, zinc, and antimony are currently the preferred choices of metal for practicing the present invention for liquid crystal display applications. For metal materials with a high boiling point, a multiplicity of arc nozzles may be used to ensure that the material is thoroughly vaporized.

Preferably the reactive gas is an oxygen-containing gas, which includes oxygen and, optionally, a predetermined amount of a second gas selected from the group consisting of argon, helium, hydrogen, carbon, nitrogen, chlorine, fluorine, boron, sulfur, phosphorus, selenium, tellurium, arsenic and combinations thereof. Argon and helium are noble gases and can be used as a carrier gas (without involving any chemical reaction) or as a means to regulate the oxidation rate. Other gases may be used to react with the metal clusters to form compound or ceramic phases of hydride, oxide, carbide, nitride, chloride, fluoride, boride, sulfide, phosphide, selenide, telluride, and arsenide in the resulting coating if so desired. The gas flow rate is preferably adjustable to provide a desired range of coating rates.

If the reactive gas contains oxygen, this reactive gas will rapidly react with the metal clusters to form nanometer-sized ceramic clusters (e.g., oxides). If the reactive gas contains a mixture of two or more reactive gases (e.g., oxygen and nitrogen), the resulting product will contain a mixture of oxide and nitride clusters. If the metal composition is a metal alloy or mixture (e.g., containing both indium and tin elements) and the reactive gas is oxygen, the resulting product will contain ultra-fine indium-tin oxide clusters that can be directed to deposit onto a glass or plastic substrate.

At a high arc temperature, metal clusters are normally capable of initiating a substantially spontaneous reaction with a reactant species (e.g., oxygen). In this case, the reaction heat released is effectively used to sustain the reactions in an already high temperature environment.

Advantages of the presently invented method are summarized as follows:
1. A wide variety of metallic elements can be readily converted into nanometer-scaled oxide clusters for deposition onto a glass or plastic substrate. The starting metal materials can be selected from any element in the periodic table that is considered to be metallic. In addition to oxygen, partner gas species may be selected from the group consisting of hydrogen, carbon, nitrogen, chlorine, fluorine, boron, sulfur, phosphorus, selenium, tellurium, arsenic and combinations thereof to help regulate the oxidation rate and, if so desired, form respectively metal hydrides, oxides, carbides, nitrides, chlorides, fluorides, borides, sulfides, phosphide, selenide, telluride, arsenide and combinations thereof. No known prior-art technique is so versatile in terms of readily producing so many different types of ceramic coatings on a substrate.
2. The metal material can be an alloy of two or more elements which are uniformly dispersed. When broken up into nano-sized clusters, these elements remain uniformly dispersed and are capable of reacting with oxygen to form uniformly mixed ceramic coating, such as indium-tin oxide. No post-fabrication mixing treatment is necessary.
3. A wire or rod can be fed into the arc zone at a relatively high rate with its leading tip readily vaporized provided that the ionized arc (or several arcs combined) gives rise to a sufficiently high temperature at the wire tip. This feature makes the method fast and effective and now makes it possible to mass produce transparent and conductive coatings on a solid substrate cost-effectively.
4. The system that is needed to carry out the invented method is simple and easy to operate. It does not require the utilization of heavy and expensive equipment such as a laser or vacuum-sputtering unit. In contrast, it is difficult for a method that involves a high vacuum to be a continuous process. The over-all product costs produced by the presently invented vacuum-free method are very low.

### BRIEF DESCRIPTION OF THE DRAWINGS

FIG. 1 shows the schematic of a system that can be used in the practice of a preferred embodiment of the presently invented method for producing oxide coating on a substrate.

FIG.2 shows the schematic of another system (a multi-arc system) that can be used in the method for producing oxide coating on a substrate.

### DETAILED DESCRIPTION OF PREFERRED EMBODIMENTS

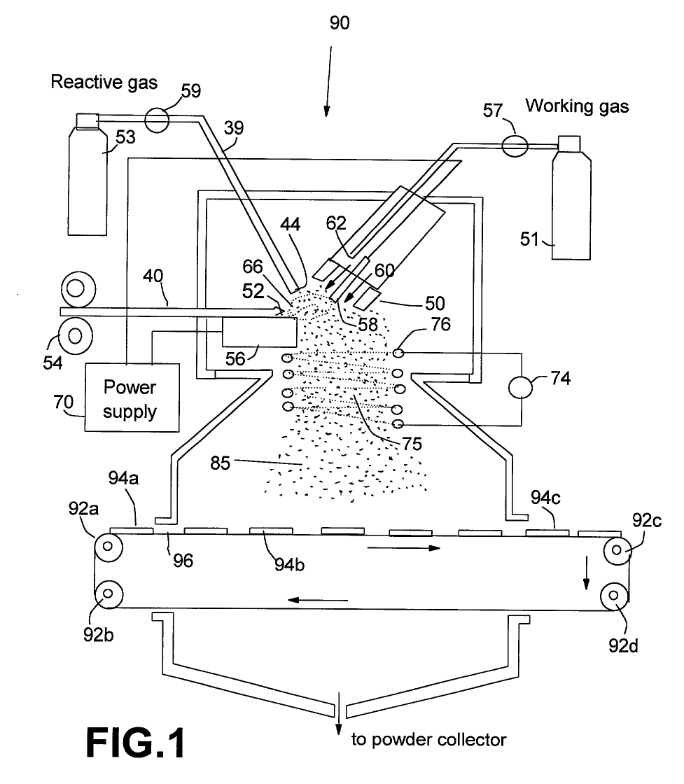

FIG. 1 schematically shows a coating system that can be used in practicing the method for producing an optically clear and electrically conductive coating on a glass or plastic substrate. This apparatus includes four major functional components: (1) a coating chamber 90, (2) an ionized arc nozzle 50 located at the upper portion of the chamber 90, (3) reactive gas-supplier (e.g., a gas bottle 53 supplying a reactive gas through a control/regulator valve 57, pipe 39 and orifice 44 into a location inside the chamber in the vicinity of the ionized arc 66), and (4) substrate supporter-conveyor (e.g., conveying rollers 92a,92b,92c,92d and belt 96).

An example of the ionized arc system constructed in accordance with the invention is shown in FIG. 1 The preparation of a thin, nano-grained coating begins with the vaporization of a precursor material 40 in the chamber 90 via an arc generated, for example, by a water-cooled tungsten inert gas torch 50 driven by a power supply 70. Although not a requirement, the interior of the chamber 90 is preferably maintained at a relative pressure of about 20 inches of mercury vacuum up to +3 psi positive pressure (absolute pressure 250 torr to 1000 torr).

The precursor material 40 is melted and vaporized by the transfer of arc energy from a non-consumable electrode 58, such as a thorium oxide-modified tungsten electrode. The non-consumable electrode 58 is shielded by a stream of an inert working gas 60 from a bottle 51 (through a gas control valve/regulator 57 and an orifice 62) to create the arc 66. The working gas 60 acts to shield the non-consumable electrode 58 from an oxidizing environment and then becomes a working plasma gas when it is ionized to a concentration large enough to establish an arc between the non-consumable electrode 58 and a consumable electrode 56.

The consumable precursor material 40 is preferably in the form of a rod or wire which has a diameter of typically from 0.1 mm to 5 mm and is fed horizontally relative to the non-consumable electrode 58. The feed wire or rod 40 of precursor material or metal material is continuously fed to allow a stable arc and continuous production of nano-grained coatings. A continuous production is preferred over batch operation because the process can be run on a more consistent and cost-effective basis. The consumable electrode 56 is preferably water-cooled.

The non-consumable tungsten electrode 58 is preferably inclined at an angle with respect to the consumable electrode 56 so as to create an elongated arc flame 66. Depending on the current level, the arc flame 66 can be about one to several inches long. The arc flame 66 acts as a high temperature source to melt and vaporize the leading end 52 of the precursor material 40 to form a stream of metal vapor clusters that are atomic- or nanometer-sized. A reactive gas (e.g. containing oxygen) is introduced from the bottle 53 through the orifice 44 into the arc 66. The amount of the reactive gas injected into the arc flame 66 is controlled by a flow meter/regulator 59. Preferably, a concentric gas injection geometry is established around the arc flame 66 to allow homogeneous insertion of the reactive gas. The reactive gas orifice 44 can be positioned at any point along the length of the arc flame 66 as shown in FIG. 1. The gas regulator or control valve 59 is used to adjust the gas flow rate as a way to vary the effective coating rate. The oxygen gas impinges upon the metal clusters to initiate and sustain an exothermic oxidation reaction between oxygen and metal clusters, thereby converting the ultra-fine metal clusters into depositable metal oxide clusters 85 that are in the liquid or, preferably, vapor state.

The arc 66, being at an ultra-high temperature (up to 6,000° C.), functions to melt and vaporize the wire tip to generate nano-sized metal vapor clusters. A stream of working gas 60 from a source 51 exits out of the orifice 62 into the chamber to help maintain the ionized arc and to carry the stream of metal vapor clusters downward toward the lower portion of the coating chamber 90. Preferably, the working gas flow and the reactive gas are directed to move in a general direction toward the solid substrate (e.g. 94b) to be coated. In FIG. 1. as an example, this direction is approximately vertically downward.

The wire or rod 40 can be fed into the arc, continuously or intermittently on demand, by a wire-feeding device (e.g., powered rollers 54). The roller speed may be varied by changing the speed of a controlling motor.

The ultra-fine oxide clusters 85 are then directed to deposit onto a glass or plastic substrate (e.g., 94b) being supported by a conveyor belt 96 which is driven by 4 conveyor rollers 92a-92d. The lower portion of FIG. 1 shows a train of substrate glass pieces, including 94a (un-coated), 94b (being coated) and 94c (coated). The oxide clusters that are not deposited will be cooled to solidify and become solid powder particles. These powder particles, along with the residual gases, are transferred through a conduit to an optional powder collector/separator system (not shown).

In another embodiment of the invented system, the wire or rod is made up of two metal elements so that a mixture of two types of nano clusters can be produced for the purpose of depositing a hybrid or composite coating material.

In a preferred embodiment, the system as defined above may further include a separate plasma arc zone below the ionized arc 66 to vaporize any un-vaporized material dripped therefrom. For instance, a dynamic plasma arc device (e.g., with power source 74 and coils 76 in FIG. 1) may be utilized to generate a plasma arc zone 75 through which the un-vaporized melt droplets dripped out of the ionized arc 66 will have another chance to get vaporized. The creation of a plasma arc zone is well-known in the art. The ultra-high temperature in the plasma arc (up to as high as 32,000° K) rapidly vaporizes the melt droplets that pass through the plasma arc zone.

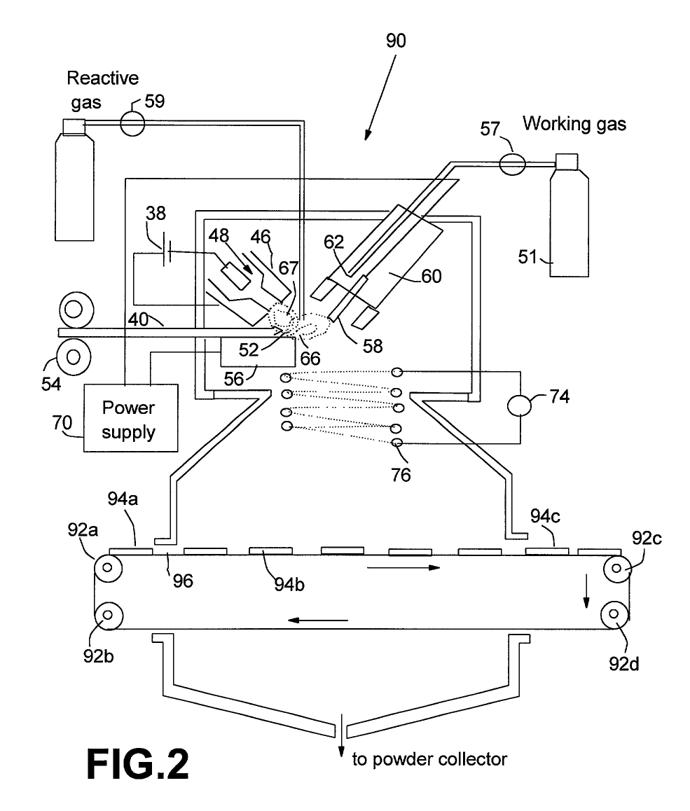

The ionized arc 66 tends to produce a metal melt pool or “weld pool” near the leading end 52 of the feed wire 40 on the top surface of the consumable electrode 56 if the arc tail temperature is not sufficiently high to fully vaporize the metal material. The melt in this pool will eventually vaporize provided that an arc is maintained to continue to heat this pool. For the purpose of reducing the duration of time required to fully vaporize the metal material and, hence, increase the coating production rate, it is preferable to operate at least a second plasma or ionized arc nozzle to generate at least a second arc (e.g., 67 in FIG. 2) near the leading end 52 of the feed wire 40. For instance, shown in FIG. 2 is a DC plasma arc nozzle 46 which is driven by a DC power source 38 and a working gas flow 48 to create an arc 67 to provide additional heat energy to the metal wire tip 52.

For the purpose of clearly defining the claims, the word “wire” means a wire of any practical diameter, e.g., from several microns (a thin wire or fiber) to several centimeters (a long, thick rod). A wire can be supplied from a spool, which could provide an uninterrupted supply of a wire as long as several miles. This is a very advantageous feature, since it makes the related coating process a continuous one.

The presently invented method is applicable to essentially all metallic materials (including pure metals and metal alloys). As used herein, the term “metal” refers to an element of Groups 2 through 13, inclusive, plus selected elements in Groups 14 and 15 of the periodic table. Thus, the term “metal” broadly refers to the following elements:
Group 2 or IIA: beryllium (Be), magnesium (Mg), calcium (Ca), strontium (Sr), barium (Ba), and radium (Ra).
Groups 3-12: transition metals (Groups IIIB, IVB, VB, VIB, VIIB, VIII, IB, and IIB), including scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), manganese (Mn), technetium (Tc), rhenium (Re), iron (Fe), ruthenium (Ru), osmium (Os). cobalt (Co), rhodium (Rh), iridium (Ir), nickel (Ni), palladium (Pd), platinum (Pt), copper (Cu), silver (Ag), gold (Au), zinc (Zn), cadmium (Cd), and mercury (Hg).
Group 13 or IIIA: boron (B), aluminum (Al), gallium (Ga), indium (In), and thallium (TI).
Lanthanides: lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).
Group 14 or IVA: germanium (Ge), tin (Sn), and lead (Pb).
Group 15 or VA: antimony (Sn) and bismuth (Bi).

When high service temperatures are not required, the component metal element may be selected from the low melting point group consisting of bismuth, cadmium, cesium, gallium, indium, lead, lithium, rubidium, tin, and zinc, etc. When a high service temperature is required, a metallic element may be selected from the high-melting refractory group consisting of tungsten, molybdenum, tantalum, hafnium and niobium. Other metals with intermediate melting points such as copper, zinc, aluminum, iron, nickel and cobalt may also be selected. However, for the purpose of producing optically transparent and electrically conductive coating, indium, tin, antimony, and zinc are the most preferred metallic elements.

Preferably the reactive gas includes oxygen and a gas selected from the group consisting of hydrogen, carbon, nitrogen, chlorine, fluorine, boron, iodine, sulfur, phosphorus, arsenic, selenium, tellurium and combinations thereof. Noble gases such as argon and helium may be used to adjust or regulate the oxidation rate. Other gases may be used to react with the metal clusters to form nanometer-scale compound or ceramic powders of hydride, oxide, carbide, nitride, chloride, fluoride, boride, iodide, sulfide, phosphide, arsenide, selenide, and telluride, and combinations thereof. The method may further include operating means for providing dissociable inert gas mixable with the working gas. The dissociable inert gas serves to increase the temperature gradient in the ionized arc.

If the reactive gas contains a reactive gas (e.g., oxygen), this reactive gas will rapidly react with the metal clusters to form nanometer-sized ceramic clusters (e.g., oxides). If the reactive gas contains a mixture of two or more reactive gases (e.g., oxygen and nitrogen), the resulting product will contain a mixture of two compounds or ceramics (e.g., oxide and nitride). If the metal wire is a metal alloy or mixture (e.g., containing both indium and tin elements) and the reactive gas is oxygen, the resulting product will contain ultra-fine indium-tin oxide particles.

In summary, a preferred embodiment of the present invention is a method for producing an optically transparent and electrically conductive coating onto a transparent substrate. The method includes four steps: (a) providing an ionized arc nozzle that includes a consumable electrode, a non-consumable electrode, and a working gas flow to form a first ionized arc between the two electrodes, wherein the consumable electrode provides a metal material vaporizable from the consumable electrode by the ionized arc; (b) operating the arc nozzle to heat and at least partially vaporize the metal material for providing a stream of nanometer-sized metal vapor clusters into a chamber in which the substrate is disposed; (c) introducing a stream of oxygen-containing gas into the chamber to impinge upon the stream of metal vapor clusters and exothermically react therewith to produce substantially nanometer-sized metal oxide clusters; and (d) directing the metal oxide clusters to deposit onto the substrate for forming the coating.

Optionally, the method may include another step of operating a plasma arc means (e.g., a dynamic plasma device including a high-frequency power source 74 and coils 76) for vaporizing any un-vaporized metal after step (c) and before step (d). Also optionally, the method may include an additional step of operating at least a second ionized arc means (e.g., a DC plasma arc nozzle 46 in FIG. 2) for vaporizing any un-vaporized metal after step (b) or metal oxide clusters after step (c) but before step (d).

In the presently invented method, the stream of reactive gas or oxygen-containing gas may further include a small amount of a second gas to produce a small proportion of compound or ceramic clusters that could serve to modify the properties of the otherwise pure oxide coating. This second gas may be selected from the group consisting of hydrogen, carbon, nitrogen, chlorine, fluorine, boron, sulfur, phosphorus, arsenic, selenium, tellurium and combinations thereof.

Preferably, the transparent substrate in the practice of the present method includes a train of individual pieces of glass or plastic being moved sequentially or concurrently into coating chamber and then moved out of the chamber after the coating is formed. This feature will make the process a continuous one.

In another embodiment of the method, the metal material may include an alloy or mixture of at least two metallic elements, with a primary one occupying more than 95% and the minor one less than 5% by atomic number. The primary one is selected so that its metal vapor clusters can be readily converted to become oxides or other ceramic clusters. However, the minor one may be allowed to remain essentially as nano-sized metal clusters. Upon deposition onto the substrate, the minor metal element only serves as a modifier to the properties (e.g., to increase the electrical conductivity) of the oxide coating. The presence of a small amount of nano-scaled metal domains does not adversely affect the optical transparency of the oxide coating.

In the presently invented method, the stream of oxygen-containing gas reacts with the metal vapor clusters in such a manner that the reaction heat released is used to sustain the reaction until most of the metal vapor clusters are substantially converted to nanometer-sized oxide clusters. The stream of oxygen-containing gas may be pre-heated to a predetermined temperature prior to being introduced to impinge upon the metal vapor clusters. A higher gas temperature promotes or accelerates the conversion of metallic clusters to compound or ceramic clusters.

### EXAMPLE 1

An Al—Cu metal alloy rod of ⅛ inch diameter was used as a precursor material disposed on a top horizontal surface of the consumable electrode. The non-consumable electrode, which was used as a cathode, was a material consisting of 2% thoriate dispersed in a matrix of W. This electrode was shielded by 25-100 cfh of a working gas of argon combined with 5-100% nitrogen and/or 5-50% hydrogen. The current of the arc was adjusted between approximately 100 and 450 amps, which generated an arc tail flame 1-4 inches long that evaporated the precursor material. The arc created a stream of metal vapor clusters of 1-200 g/hr while an oxygen flow of 10-1000 cfh was injected into the tail flame to form mixed oxide vapor clusters of the starting metal alloy. These vapor clusters were directed to deposit on a glass substrate. The micro-structure of the resulting coatings was typically characterized by grain sizes in the range of 1-50 nm. The room-temperature p-type conductivity of these coatings were approximately 1 S/cm.

### EXAMPLE 2

A powder mixture of 70% tin and 30% indium was compounded into a rod ½ diameter by pressing and sintering. The rod was electrically conductive and used as a precursor material in the consumable electrode or anode. The same cathode as in Example 1 was used and shielded by approximately 50 cfh of a working gas of argon in combined with 5-50% nitrogen or 5-50% hydrogen. The current of the arc ranged from 100-450 amps. The precursor material was evaporated by the arc to produce a vapor of 1-200 g/hr in a plasma tail flame created by the transferred arc. Concurrently, 10-500 cfh oxygen was injected into the tail flame to produce complete indium-tin oxide vapor clusters. These oxide clusters were directed to deposit onto a glass. The coatings were found to be nano-grained with grain sizes of 5-35 nm. The room-temperature n-type conductivity of these coatings were approximately 5.5×10³ S/cm.

### EXAMPLE 3

The process of Example 2 was repeated except that tin was replaced by zinc. The resulting indium-zinc oxide coating exhibited grain sizes in the range of 3 to 25 nm. The room-temperature n-type conductivity of these coatings were approximately 3.5×10 ³ S/cm.

### EXAMPLE 4

The process of Example 1 was repeated except that the aluminum-copper rod was replaced by a zinc wire of ⅛ inches diameter. The resulting zinc oxide coating exhibited grain sizes in the range of 3 to 35 nm. The room-temperature conductivity of these coatings were approximately 3×10³ S/cm.

1. A method for producing an optically transparent and electrically conductive coating onto a solid substrate, said method comprising:
(a) providing an ionized arc nozzle means comprising a consumable electrode, a non-consumable electrode, and a working gas flow to form an ionized arc between said consumable electrode and said non-consumable electrode, wherein said consumable electrode provides a metal material vaporizable therefrom by said ionized arc;
(b) operating said arc nozzle means to heat and at least partially vaporize said metal material for providing a stream of nanometer-sized vapor clusters of said metal material into a chamber in which said substrate is disposed;
(c) introducing a stream of oxygen-containing gas into said chamber to impinge upon said stream of metal vapor clusters and exothermically react therewith to produce substantially nanometer-sized metal oxide clusters; and
(d) directing said metal oxide clusters to deposit onto said substrate for forming said coating.

2. The method as set forth in claim 1, further comprising a step of operating at least a second ionized arc nozzle means for the purpose of completely vaporizing said metal material.

3. The method as set forth in claim 1, further comprising a step of operating a separate plasma arc means for vaporizing any un-vaporized metal oxide clusters after step (c) and before step (d).

4. The method as set forth in claim 1, 2, or 3, wherein said metal material comprises at least one metallic element selected from the low melting point group consisting of bismuth, cadmium, antimony, cesium, gallium, indium, lead, lithium, rubidium, tin, and zinc.

5. The method as set forth in claim 1, 2, or 3, wherein said metal material comprises indium and tin elements.

6. The method as set forth in claim 1, 2, or 3, wherein said stream of oxygen-containing gas further comprises a gas selected from the group consisting of argon, helium, hydrogen, carbon, nitrogen, chlorine, fluorine, boron, sulfur, phosphorus, selenium, tellurium, arsenic and combinations thereof.

7. The method as set forth in claim 1, 2, or 3, wherein said solid substrate comprises a train of individual pieces of glass or plastic being moved sequentially or concurrently into said chamber and then moved out of said chamber after said coating is formed.

8. The method as set forth in claim 1, 2, or 3, wherein said metal material comprises an alloy of at least two metallic elements.

9. The method as set forth in claim 1, 2, or 3, wherein said stream of oxygen-containing gas reacts with said metal vapor clusters in such a manner that the reaction heat released is used to sustain the reaction until most of said metal vapor clusters are substantially converted to nanometer-sized oxide clusters.

10. The method as set forth in claim 1, 2, or 3, wherein said stream of oxygen-containing gas is pre-heated to a predetermined temperature prior to being introduced to impinge upon said metal vapor clusters.

11. The method as defined in claim 1, 2, or 3 wherein said working gas is selected from the group consisting of nitrogen, hydrogen, noble gases and mixtures thereof.

12. The method as defined in claim 1, 2, or 3 wherein said working gas comprises dissociable inert gas for increasing the temperature gradient in said ionized arc.
